(19) United States
(12) Patent Application Publication
(10) Pub. No.: US 2013/0160696 A1
(43) Pub. Date: Jun. 27, 2013

(54) PRESSURE GAUGE

(71) Applicant: Hung-Yeh Cheng, New Taipei (TW)

(72) Inventor: Hung-Yeh Cheng, New Taipei (TW)

(21) Appl. No.: 13/337,057

(22) Filed: Dec. 24, 2011

(51) Int. Cl. G01L 19/12

(52) U.S. Cl. 116/271

(57) ABSTRACT

A pressure gauge includes a gauge base rotably disposed on a rotating shaft and a sectored gear disk of the gauge base, an indicating needle coupled to an end of the rotating shaft, and a reed pipe coupled to a pressure source, and the rotating shaft has an engaging portion engaged with the sectored gear disk for a transmission, and the pressure gauge is characterized in that the reed pipe has a lever installed at a movable end of the reed pipe, and the sectored gear disk has a latch hole for latching the corresponding lever, and when an end of the reed pipe is moved by a change of pressure, the lever is linked to the latch hole to rotate the sectored gear disk, so as to drive and turn the indicating needle linked with the rotating shaft.

### FIELD OF THE INVENTION

The present invention relates to a pressure gauge, in particular to the pressure gauge used for measuring the pressure of a fluid.

### BACKGROUND OF THE INVENTION

With reference to FIG. 1 for the structure of a conventional pressure gauge 1, the conventional pressure gauge comprises a gauge base 11 disposed in a curved reed pipe 12 inside the gauge base 11, a rotatable gear disk link rod 13, a gear shaft 14, an indicating needle 15 coupled to the gear shaft 14, and a position-restoring coil spring 16. Wherein, the curved reed pipe 12 can be connected to a pressure source and the curvature of the curved reed pipe 12 varies with the pressure, and a serrated end of the gear disk link rod 13 drives and rotates the gear shaft 14 to turn the indicating needle 15, and the turning of the indicating needle 15 indicates the value of a pressure on a calibrated dial (not shown in the figure). In the meantime, the rotation of the gear shaft 14 drives the position-restoring coil spring 16 to store an elastic potential energy that provides the force of resuming the gear shaft 14 to its original position.

However, the aforementioned conventional pressure gauge 1 has the drawback of a relatively large volume which is not suitable for the use in a smaller space, and the way of using the serrated end of the gear disk link rod 13 to drive and rotate the gear shaft 14 in order to turn the indicating needle 15 generally gives a relatively small turning angle (at most up to 90 degrees), so that the precision of the indication is relatively low.

### SUMMARY OF THE INVENTION

In view of the shortcomings of the prior art, it is a primary objective of the present invention to provide a pressure gauge with a small volume and improve the precision of the indication.

To achieve the aforementioned objective, the present invention provides a pressure gauge comprising: a gauge base rotably disposed on a rotating shaft and a sectored gear disk of the gauge base, an indicating needle coupled to an end of the rotating shaft, and a reed pipe connected to a pressure source, wherein the rotating shaft has an engaging portion engaged with the sectored gear disk for performing a transmission, and the pressure gauge is characterized in that the reed pipe has a lever installed at a movable end of the reed pipe, and the sectored gear disk has a latch hole for latching the corresponding lever, and when an end of the reed pipe is moved by a change of pressure, the lever is linked to the latch hole to rotate the sectored gear disk, so as to drive and turn the indicating needle linked with the rotating shaft.

### BRIEF DESCRIPTION OF THE DRAWINGS

FIG. 1 is a cross-sectional view of a conventional pressure gauge; and

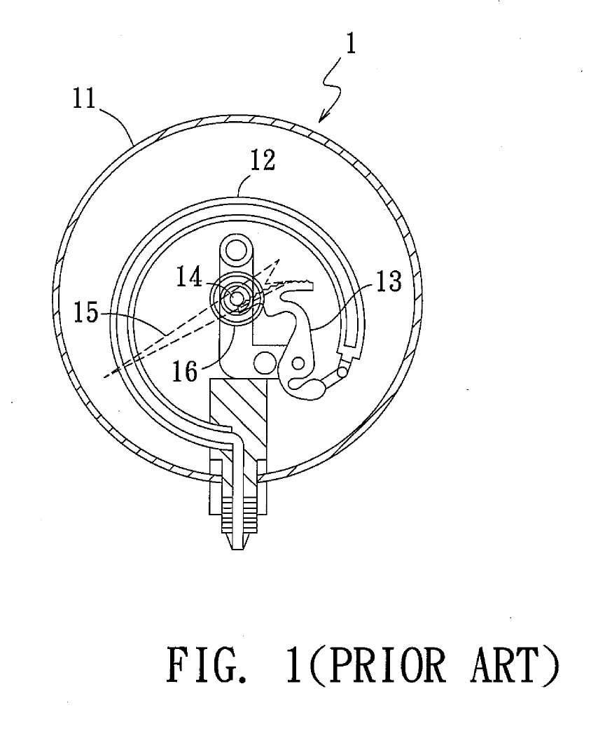

FIG. 2 is a schematic view of a pressure gauge in accordance with a preferred embodiment of the present invention.

### DESCRIPTION OF THE PREFERRED EMBODIMENTS

The aforementioned and other technical contents of the present invention will become apparent with the detailed description of a preferred embodiment together with the illustration of related drawings as follows.

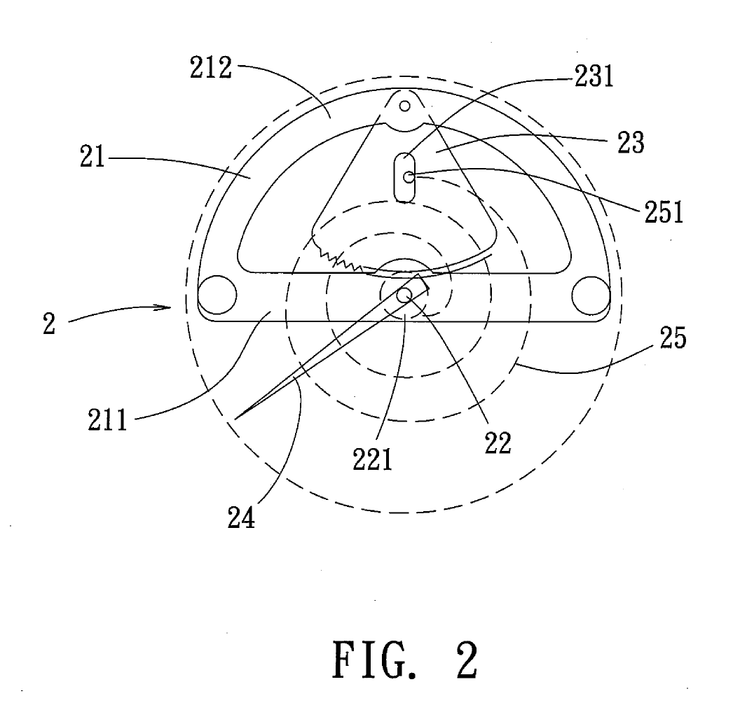

With reference to FIG. 2 for a pressure gauge 2 of the present invention, the pressure gauge 2 comprises a gauge base 21 rotably disposed on a rotating shaft 22 and a sectored gear disk 23 of the gauge base 21, an indicating needle 24 coupled to an end of the rotating shaft 22, and a reed pipe 25 connected to a pressure source.

The gauge base 21 includes a first support portion 211 and a second support portion 212, and the first support portion 211 is extended linearly in a horizontal direction and disposed at a position penetrating through the central position of the gauge, and the second support portion 212 is coupled to both ends of the first support portion 211 to form a semicircular shape, and the rotating shaft 22 is rotably installed at a mid-point position of the first support portion 211, and the sectored gear disk 23 is rotably installed at a mid-point position of the second support portion 212.

The rotating shaft 22 has an engaging portion 221 disposed thereon, and the engaging portion 221 of the preferred embodiment is a gear used for engaging with a serrated edge of the sectored gear disk 23. In addition, the rotating shaft 22 further includes a coil spring (not shown in the figure) installed thereon for providing a restoring force to resume the rotating shaft 22 (or the indicating needle 24) to its original position.

The reed pipe 25 is substantially in a spiral shape and disposed near the central position for interconnecting a pressure source, and a lever 251 is disposed at the movable end on the outer side, such that when there is pressure, the lever 251 will be moved in a direction away from the center, and the sectored gear disk 23 will drive the lever 251 to pass through and be latched into a latch hole 231. When an end of the reed pipe 25 is moved by a change of pressure, the lever 251 linked with the latch hole 231 drives and rotates the sectored gear disk 23, so as to drive and turn the indicating needle 24 linked with the rotating shaft 22.

With the installation of the aforementioned components, the overall volume is concentrated and reduced. In the meantime, the sectored gear disk 23 is provided for driving the rotating shaft 22, so the range of turning the indicating needle 24 can be increased up to 270 degrees to enhance the precision of the indication significantly.

While the invention has been described by means of specific embodiments, numerous modifications and variations could be made thereto by those skilled in the art without departing from the scope and spirit of the invention set forth in the claims.

What is claimed is:

1. A pressure gauge, comprising: a gauge base, rotably disposed on a rotating shaft and a sectored gear disk of the gauge base, an indicating needle coupled to an end of the rotating shaft, and a reed pipe coupled to a pressure source, and the rotating shaft having an engaging portion engaged with the sectored gear disk for a transmission, characterized in that the reed pipe has a lever installed at a movable end of the reed pipe, and the sectored gear disk has a latch hole for latching the corresponding lever, and when an end of the reed pipe is moved by a change of pressure, the lever is linked to the latch hole to rotate the sectored gear disk, so as to drive and turn the indicating needle linked with the rotating shaft.

2. The pressure gauge of claim 1, wherein the engaging portion disposed on the rotating shaft is a gear.

3. The pressure gauge of claim 1, wherein the gauge base has a first support portion and a second support portion coupled to the first support portion, and the rotating shaft is rotably installed at the first support portion, and the sectored gear disk is rotably installed at the second support portion .
